(19) United States
(12) Patent Application Publication
(10) Pub. No.: US 2001/0050311 A1
(43) Pub. Date: Dec. 13, 2001

(54) Gaming machine credit card

(76) Inventor: Michael Avellino, New York, NY (US)

Correspondence Address: Daniel M. Cislo, Cislo & Thomas LLP, Suite 900, 233 Wilshire Blvd., Santa Monica, CA, 90401, US

(21) Appl. No.: 09/815,361

(22) Filed: Mar. 21, 2001

Related U.S. Application Data
(60) Provisional application No. 60/195,126, filed on Apr. 6, 2000.

(51) Int. Cl. G06K 5/00

(52) U.S. Cl. 235/380

(57) ABSTRACT

A gaming machine credit card that comprises a front face and a rear face, having a cardholder identification and player identification located on the front face or the rear face and a magnetic strip located on the rear face. The magnetic strip allowing communication with a plurality of gaming machines, whereby allowing values to be added to and subtracted from the gaming machine credit card and allowing a cardholder to use the gaming machine credit card as a substitute for cash in gaming machines.

### CROSS-REFERENCE TO RELATED APPLICATIONS

This patent application is related to United States Provisional Patent Application Se. No. 60/195,126 filed Apr. 6, 2000 for SLOT MACHINE CREDIT CARD, which application is incorporated herein by this reference thereto.

### BACKGROUND OF THE INVENTION

1. Field of the Invention

This invention relates to generally to a credit card and more specifically to a credit card that is to be used solely with gaming machines and gaming establishments.

2. Description of the Related Art

The slot machine, commonly referred to as a one armed bandit, is a gambling device into which coins or bills are inserted and a handle pulled or button pressed to activate internal wheels marked by colorful symbols, such as numbers, fruits, card suits, words, etc. At present, computer generated slot machines exist as well and these wheels are generated on a computer screen. Specific alignments of symbols cause the machine to release amounts of money as winnings to the user. Originally, slot machines were entirely mechanical but now contain electronic circuitry and can be programmed to regulate payouts. Slot machines are legal in various forms in quite a number of states throughout the United States and in other countries.

U.S. Pat. No. 5,371,345 issued to LeStrange et al. on Dec. 6, 1994 for a Gaming Machine Change System. Referring to the drawing, a change card can be inserted into a gaming machine by a casino employee and by a code input units can be added to the gaming machine without the need to disperse money in coin form to the user. No provision is made for enabling the user to move from machine to machine without having to collect coins from the first machine or without having to change denominations of said coins.

U.S. Pat. No. 4,880,237 issued to Kishishita on Nov. 14, 1989 for a Tokenless Slot Machine System. Referring to FIG. 2B, the arithmetic processing unit 10d calculates the number of the present game media by adding the data of the game results to or subtracting it from the initial number of game media TS in the game data previously stored. No provision is made for allowing the user the ability to change to different types of gaming machines.

U.S. Pat. No. 4,575,622 issued to Pellegrini on Mar. 11, 1986 for an Electronic Access Control System for Coin-Operated Games and Like Selectively Accessible Devices. A system is disclosed allowing for a card to be purchased having units and allowing a machine to read and deduct these units when playing an electronic device, such as an arcade game. No provision is made for allowing a change in denomination for the play of different electronic devices.

Consequently, it remains to be seen and developed in the art that a gaming machine credit card can be established that provides abilities to play at many different types of machines no matter what denomination of currency is needed.

### SUMMARY OF THE INVENTION

The present invention is that of a credit card that is to be used solely with gaming machines and gaming establishments. The preferred embodiment of the present invention would be designed in a “credit card style” arrangement. The preferred embodiment, rather than having a 16-digit credit card number, would have a player identification number that would be unique to each cardholder or player registered with a particular casino. This embodiment would also include a magnetic strip on its reverse side that would keep track of a player's amount of credit available. The present invention would be preferably used for gaming machine play, and once inserted into a gaming machine, would be capable of adding and subtracting finds as they are won and lost by a gaming machine player.

Another embodiment of the present invention would come in a “phone card style” type of arrangement. This other embodiment, rather than having a 16-digit credit card number, would have a card identification number that would be unique to each issued card. In addition, a ‘scratch-off’ pin number would be present on each card. On each gaming machine, a user would be able to type in the card identification number and pin number of a particular card, which would then recall the amount of money associated with the particular card being used. Winnings would be added and subtracted from this account until a user would leave the machine, taking his card with him, or play until he got to a zero balance, at which time the card would no longer be of any use.

### OBJECTS OF THE INVENTION

It is an object of the present invention to provide a gaming machine credit card that can be inserted into a gaming machine.

It is a further object of the present invention to reduce casino labor.

It is yet a further object of the present invention to reduce breakdowns on gaming machines caused by coin usage in order to produce non-interrupted play.

It is yet a further object of the present invention to eliminate theft from slugs and foreign objects being placed into the gaming machines.

It is yet a further object of the present invention to reduce the time spent with casinos counting a plurality of coins.

It is yet a further object of the present invention to allow the user to jump from gaming machine to gaming machine without concern to the change in coin denomination.

It is yet a further object of the present invention to reduce the hassles of carrying around heavy containers of coins in turn reducing the risk of losing money if bumped into or knocked over.

These and other objects and advantages of the present invention will be apparent from a review of the following specification and accompanying drawings.

### BRIEF DESCRIPTION OF THE DRAWINGS

FIG. 1 represents a front perspective view of the preferred embodiment of the present invention.

FIG. 2 represents a rear perspective view of the preferred embodiment of the present invention.

FIG. 3 represents a gaming machine used by the present invention.

FIG. 4 represents a front perspective view of another embodiment of the present invention.

FIG. 5 represents a rear perspective view of another embodiment of the present invention.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

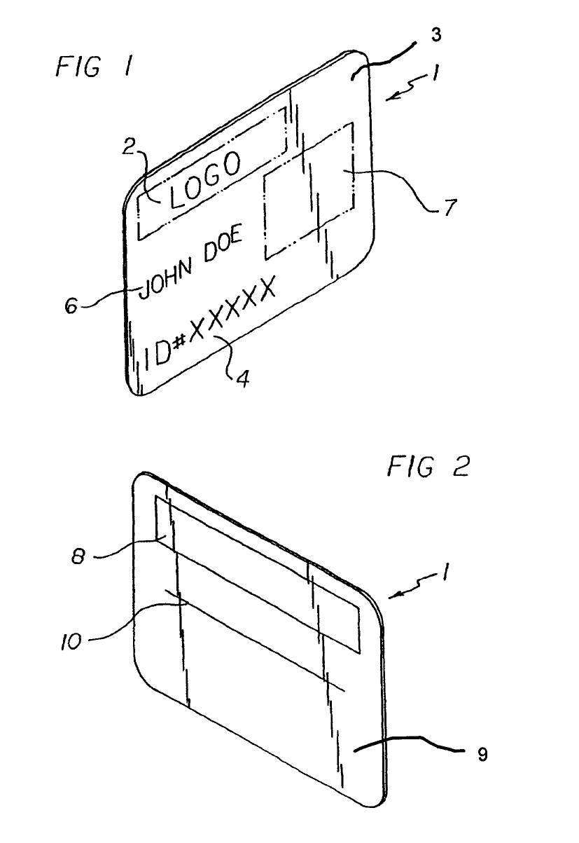

Referring now to FIGS. 1 and 2, front and rear perspective views of the gaming machine credit card 1 are shown. Logo 2 is seen, with logo 2 being an identification marker for a particular casino, gaming company, or hotel with gaming machines. Cardholder identification 4 would also be present on the front face 3 of the gaming machine credit card 1, allowing for a personalized touch of the present invention for a particular gambler. In addition, player identification 6 is also present on the front face 3 of the gaming machine credit card 1, thereby allowing a casino or gaming company to keep track of a user in their computers by name, address, telephone number, and other pertinent information. Player identification 6 and cardholder identification 4 can be located on the front face 3, rear face 9, or both the front face 3 and rear face 9 of the gaming machine credit card 1. In other embodiments, a player identification 6 may not be required as the user may be identified by the cardholder identification 4. The gaming machine credit card 1 can also include a design 7 that would further identify the card with a specific casino or gaming company, with design 7 being located on the front face 3, rear face 9, or both the front face 3 and rear face 9 of the gaming machine credit card 1.

The gaming machine credit card 1 also includes a magnetic strip 8 and signature line 10 on its rear face 9. The magnetic strip 8 allows a current cash value to be magnetically imprinted on this card and link up with a plurality of gaming machines. The magnetic strip 8 would allow communication with a plurality of gaming machines whereby values can be added to and subtracted from the gaming machine credit card 1 and can allow a user to use the gaming machine credit card 1 as a substitute for cash in the gaming machines. Therefore, a user would not have to use the entire value of a particular gaming machine credit card 1 at one time, and could use and re-use a particular card until its value would be used up or exchange the card for its cash value at any time.

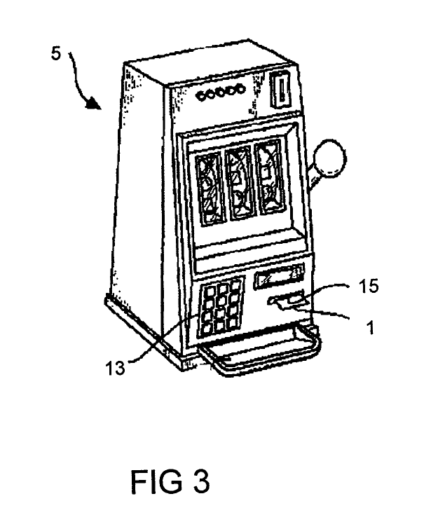

The magnetic strip 8 contains data that is accessible by the gaming machine 5, shown in FIG. 3. This data includes cardholder contact information, a personal identification number and the amount of credit available on the gaming machine credit card 1. The gaming machine 5 communicates with the gaming machine credit card 1 by reading from and writing to the accessible data. When the gaming machine credit card 1 is inserted into the slot 15 of the gaming machine 5, the user is prompted to enter his personal identification number onto the keypad 13 of the gaming machine 15. The accessible data is operatively associated with the user inputting the correct personal identification number. If the user enters the correct personal identification number, than the gaming machine 5 reads the amount of credit available from magnetic strip 8 of the gaming machine credit card 1. If the user inputs the wrong personal identification number, than the gaming machine 5 will not read the amount of credit available and the card would have to be reinserted into the slot 15 of the gaming machine 15. Also, the amount of credit available is operatively associated with the activation of the gaming machine 5. For instance, if the amount of credit available is less than the amount of credit needed to activate the gaming machine 5, the gaming machine 5 will not activate. If the amount of credit available is equal to or greater than the amount of credit needed, then the gaming machine 5 will activate and write the new value of the amount of credit remaining to the magnetic strip 8 of the gaming machine credit card 1 based upon a win or loss on that activation. The magnetic strip 8 also allows communication with a computer system where the communication between the computer system and the magnetic strip 8 consists of reading from and writing to the accessible data.

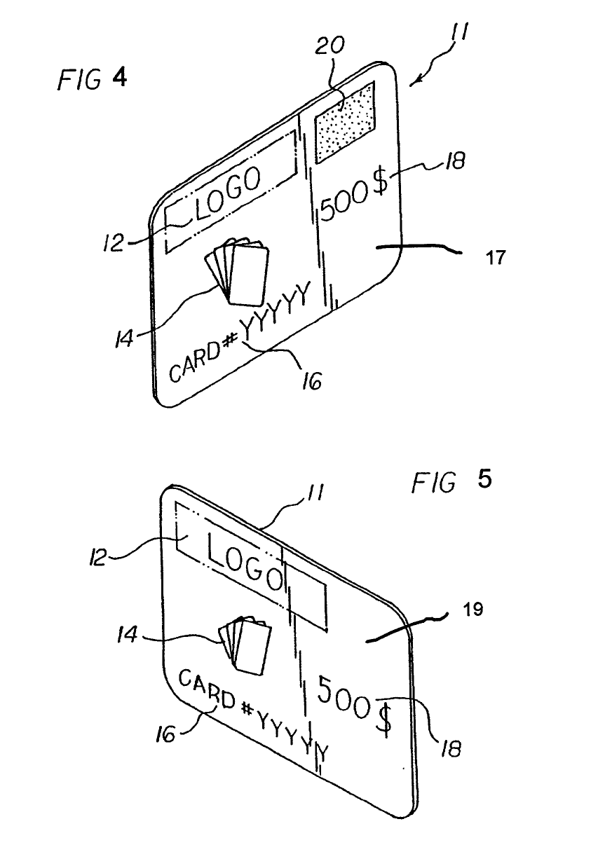

FIGS. 4 and 5 show a front and rear perspective view of another embodiment of the gaming machine credit card 11. This embodiment includes a plurality of gaming machines 5, like the one shown in FIG. 3. As in the preferred embodiment, the gaming machine credit card 11 has a front face 17 and a rear face 19. This embodiment of the present invention includes a logo 12 and a design 14, or company identification, a card identification number 16, and an issued amount location 18 on its front face 17. These also can be present on the rear face 19 of the gaming machine credit card 11. The initial issued amount can be selected from a group consisting of $1, $5, $10, $20, $50, $100, $500, $1000 and $10000. However, the gaming machine credit card 11 may also be accessible in different denominations than the ones mentioned herein.

The card identification number 16 would be a combination of numbers and letters, but can be only numbers or only letters and will be unique to each issued card. In addition, a pin number(not shown), like the card identification number 16 is a combination of numbers and letters, but can be only numbers or only letters, and will be present on the front face 17 of each card. The pin number(not shown) will be covered by a removable layer 20 that is scratchably removable by the user after purchase. The card identification number 16 and the pin number(not shown) are operatively associated with an amount of credit available on the gaming machines 5. The plurality of gaming machines 5 will store the amount of credit available and will access it when the user enters the correct combination of the card identification number 16 and pin number (not shown). On each gaming machine 5, a user would be able to key in the card identification number 16 and pin number(not shown) of a particular card into the keypad 13, which would then recall the amount of money associated with the particular card being used. The keypad 13 will consist of a combination of numbers and letters, but can also be only numbers or only letters. Winnings would be added to and subtracted from this account until a user would leave the machine or play until he got to a zero balance, at which time the card would no longer be of any use.

FIG. 4 shows a rear perspective view of the gaming machine credit card 11 of the present invention. As can be seen, the rear side of the gaming machine credit card 11 of the present invention can also include logo 12, design 14, card identification number 16, and an issued amount location 18, but is not required to.

While the present invention has been described with regards to particular embodiments, it is recognized that additional variations of the present invention may be devised without departing from the inventive concept.

What is claimed is:

1. A gaming machine credit card, comprising
a front face and a rear face,
a cardholder identification, said cardholder identification located on said front face or said rear face,
a player identification, said player identification located on said front face or said rear face,
a magnetic strip, said magnetic strip located on said rear face,
said magnetic strip allowing communication with a plurality of gaming machines;
whereby allowing values to be added to and subtracted from said gaming machine credit card and allowing a cardholder to use said gaming machine credit card as a substitute for cash in said gaming machines.

2. A gaming machine credit card as set forth in claim 1, wherein
said magnetic strip contains accessible data, said accessible data comprising contact information of said cardholder, a personal identification number and an amount of credit available,
said communication between said magnetic strip and said gaming machines consisting of reading from and writing to said accessible data.

3. A gaming machine credit card as set forth in claim 2, wherein
said gaming machine reads said amount of credit available,
said amount of credit available operatively associated with activation of said gaming machine.

4. A gaming machine credit card as set forth in claim 3, wherein
said accessible data operatively associated with said user inputting said personal identification number.

5. A gaming machine credit card as set forth in claim 4, wherein
said magnetic strip allowing communication with a computer system,
said communication between said magnetic strip and said computer system consisting of reading from and writing to said accessible data,
said gaming machines and said computer system storing said accessible data.

6. A gaming machine credit card as set forth in claim 5, further comprising
a logo, said logo located on said front face, said logo identifying a particular casino or gaming company.

7. A gaming machine credit card, comprising
a front face and a rear face,
a cardholder identification, said cardholder identification located on said front face or said rear face,
a player identification, said player identification located on said front face or said rear face,
a magnetic strip, said magnetic strip located on said rear face,
a logo, said logo located on said front face, said logo identifying a particular casino or gaming company,
said magnetic strip allowing communication with a plurality of gaming machines
said magnetic strip contains accessible data,
said accessible data comprising contact information of said cardholder, a personal identification number and an amount of credit available,
said communication between said magnetic strip and said gaming machines consisting of reading from and writing to said accessible data,
said gaming machine reads said amount of credit available,
said amount of credit available operatively associated with activation of said gaming machine,
said accessible data operatively associated with said user inputting said personal identification number,
said magnetic strip allowing communication with a computer system,
said communication between said magnetic strip and said computer system consisting of reading from and writing to said accessible data,
said gaming machines and said computer system storing said accessible data;
whereby allowing values to be added to and subtracted from said gaming machine credit card and allowing a cardholder to use said gaming machine credit card as a substitute for cash in said gaming machines.

8. A gaming machine credit card system, comprising
a plurality of gaming machines,
a gaming machine credit card,
said gaming machine credit card having a front face and a rear face,
a cardholder identification, said cardholder identification located on said front or said rear face,
a card identification number, said card identification number located on said front or said rear face,
an initial issued amount, said initial issued amount located on said front or said rear face,
a pin number, said pin number located on said front face,
said plurality of gaming machines comprising a keypad, said keypad comprising numbers and letters,
a user entering said card identification number and said pin number into said keypad, said card identification number and said pin number operatively associated with an amount of credit available on said plurality of said gaming machines;
whereby said gaming machine credit card system is used to place a value on said gaming machine and associating said value with said card identification number and said pin number allowing said user to carry said value to said plurality of gaming machines.

9. A gaming machine credit card system as set forth in claim 8, wherein
said initial issued amount selected from a group consisting of $1, $5, $10, $20, $50, $100, $500, $1000 and $10000.

10. A gaming machine credit card system as set forth in claim 9, wherein
said pin number covered by a removable layer,
said removable layer being scratchably removable from said front face revealing said pin number.

11. A gaming machine credit card system as set forth in claim 10, wherein
said card identification number comprising a combination of numbers and letters,
said pin number comprising a combination of numbers and letters.

12. A gaming machine credit card system, comprising
a plurality of gaming machines,
a gaming machine credit card,
said gaming machine credit card having a front face and a rear face,
a cardholder identification, said cardholder identification located on said front or said rear face,
a card identification number, said card identification number located on said front or said rear face,
an initial issued amount, said initial issued amount located on said front or said rear face,
a pin number, said pin number located on said front face,
said plurality of gaming machines comprising a keypad, said keypad comprising numbers and letters,
a user entering said card identification number and said pin number into said keypad, said card identification number and said pin number operatively associated with an amount of credit available on said plurality of said gaming machines,
said initial issued amount selected from a group consisting of $1, $5, $10, $20, $50, $100, $500, $1000 and $10000,
said pin number covered by a removable layer,
said removable layer being scratchably removable from said front face revealing said pin number,
said card identification number comprising a combination of numbers and letters,
said pin number comprising a combination of numbers and letters;
whereby said gaming machine credit card system is used to place a value on said gaming machine and associating said value with said card identification number and said pin number allowing said user to carry said value in a said gaming machine credit card to said plurality of gaming machines.
